(19) United States
(12) Patent Application Publication
(10) Pub. No.: US 2015/0381727 A1
(43) Pub. Date: Dec. 31, 2015

(54) STORAGE FUNCTIONALITY RULE IMPLEMENTATION

(71) Applicant: NetApp Inc., Sunnyvale, CA (US)

(72) Inventors: Mark Muhlestein, Sunnyvale, CA (US); Chinmoy Dey, West Bengal (IN); Mankawaldeep Singh, Bangalore (IN)

(21) Appl. No.: 14/319,495

(22) Filed: Jun. 30, 2014

(51) Int. Cl. H04L 29/08; G06F 17/30

(52) U.S. Cl. CPC H04L 67/1097; H04L 67/1095; G06F 17/30082; G06F 17/30233; G06F 17/302

(57) ABSTRACT

One or more techniques and/or systems are provided for storage functionality rule implementation on behalf of external client agents. For example, a network storage controller may be configured to perform storage operations on behalf of clients, such as providing read/write access to storage devices. The network storage controller may receive a storage functionality rule (e.g., a rule that tracing is to be enabled for write operations by user (B)) from an external client agent hosted on a client device. Responsive to identify a storage operation context that corresponds to the storage functionality rule (e.g., user (B) may attempt to perform a write operation), the network storage controller may implement the storage functionality rule for the storage operation context on behalf of the external client agent. In this way, network bandwidth and/or processing latency otherwise associated with obtaining storage operation processing instructions from the external client agent may be mitigated.

### BACKGROUND

A storage environment may comprise a network storage controller configured to provide one or more clients with access to storage devices. For example, the network storage controller may provide a client with read and write access to data stored across one or more storage devices.

### DESCRIPTION OF THE DRAWINGS

FIG. 1 is a component block diagram illustrating an example clustered network in accordance with one or more of the provisions set forth herein.

FIG. 2 is a component block diagram illustrating an example data storage system in accordance with one or more of the provisions set forth herein.

FIG. 3 is a flow chart illustrating an exemplary method of storage functionality rule implementation on behalf of external client agents.

FIG. 4A is a component block diagram illustrating an exemplary system for storage functionality rule implementation on behalf of external client agents, where a storage operation context (C) is received.

FIG. 4B is a component block diagram illustrating an exemplary system for storage functionality rule implementation on behalf of external client agents, where a storage functionality rule is received.

FIG. 4C is a component block diagram illustrating an exemplary system for storage functionality rule implementation on behalf of external client agents, where a storage functionality rule is implemented on behalf of an external client agent.

FIG. 4D is a component block diagram illustrating an exemplary system for storage functionality rule implementation on behalf of external client agents, where a storage result repository is synchronized with an external client agent.

FIG. 5 is an example of a storage rule repository comprising one or more storage functionality rules.

FIG. 6 is an example of a computer readable medium in accordance with one or more of the provisions set forth herein.

### DETAILED DESCRIPTION

Some examples of the claimed subject matter are now described with reference to the drawings, where like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. Nothing in this detailed description is admitted as prior art.

One or more systems and/or techniques for storage functionality rule implementation on behalf of external client agents are provided. A network storage controller may be configured to perform storage operations for clients, such as providing a client with read access to a storage device. The network storage controller may host a rule set management component and/or a rule evaluation component. The rule set management component may be configured to receive a storage functionality rule from an external client agent hosted on a client device remote to the network storage controller (e.g., an administrative server maintained by an entity that manages the client device). For example, the storage functionality rule may specify that a first client is allowed to store up to 2 GB of data files having the extension .mp3. The rule set management component may verify that the storage functionality rule adheres to a storage rule language syntax.

The rule evaluation component may be configured to implement the storage functionality rule, on behalf of the external client agent, for a storage operation context that corresponds to the storage functionality rule. For example, the rule evaluation component may identify the storage operation context as corresponding to a write operation of an mp3 file by the first client. Accordingly, the rule evaluation component may either allow the write operation or deny the write operation, on behalf of the external client agent, based upon whether the write operation could be performed without the first client exceeding the 2 GB data file limit for mp3s. Because the rule evaluation component on the storage controller does not need to request the external client agent on the client device to make the determination as to whether to allow or deny the write operation, network latency issues, congestion issues associated with waiting on an instruction from the external client agent, connectivity issues with contacting the client device, and/or bandwidth issues associated with sending relatively large amounts of data between the storage controller and the client device may be mitigated.

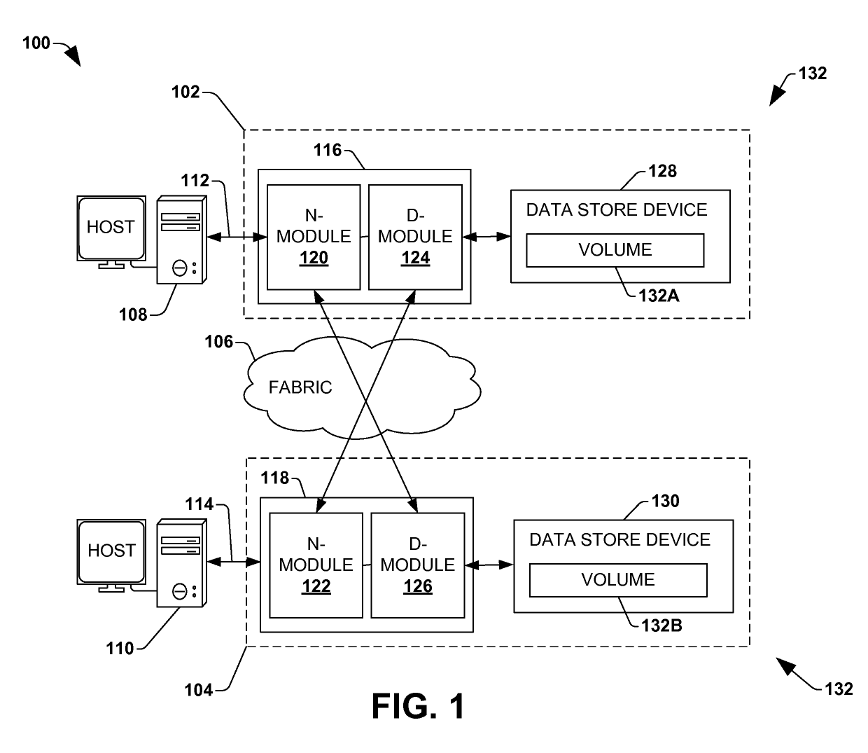

To provide context for storage functionality rule implementation on behalf of external client agents, FIG. 1 illustrates an embodiment of a clustered network environment or a network storage environment 100. It may be appreciated, however, that the techniques, etc. described herein may be implemented within the clustered network environment 100, a non-cluster network environment, and/or a variety of other computing environments, such as a desktop computing environment. That is, the instant disclosure, including the scope of the appended claims, is not meant to be limited to the examples provided herein. It will be appreciated that where the same or similar components, elements, features, items, modules, etc. are illustrated in later figures but were previously discussed with regard to prior figures, that a similar (e.g., redundant) discussion of the same may be omitted when describing the subsequent figures (e.g., for purposes of simplicity and ease of understanding).

FIG. 1 is a block diagram illustrating an example clustered network environment 100 that may implement at least some embodiments of the techniques and/or systems described herein. The example environment 100 comprises data storage systems or storage sites 102 and 104 that are coupled over a cluster fabric 106, such as a computing network embodied as a private Infiniband or Fibre Channel (FC) network facilitating communication between the storage systems 102 and 104 (and one or more modules, component, etc. therein, such as, nodes 116 and 118, for example). It will be appreciated that while two data storage systems 102 and 104 and two nodes 116 and 118 are illustrated in FIG. 1, that any suitable number of such components is contemplated. In an example, nodes 116, 118 comprise storage controllers (e.g., node 116 may comprise a primary or local storage controller and node 118 may comprise a secondary or remote storage controller) that provide client devices, such as host devices 108, 110, with access to data stored within data storage devices 128, 130. Similarly, unless specifically provided otherwise herein, the same is true for other modules, elements, features, items, etc. referenced herein and/or illustrated in the accompanying drawings. That is, a particular number of components, modules, elements, features, items, etc. disclosed herein is not meant to be interpreted in a limiting manner.

It will be further appreciated that clustered networks are not limited to any particular geographic areas and can be clustered locally and/or remotely. Thus, in one embodiment a clustered network can be distributed over a plurality of storage systems and/or nodes located in a plurality of geographic locations; while in another embodiment a clustered network can include data storage systems (e.g., 102, 104) residing in a same geographic location (e.g., in a single onsite rack of data storage devices).

In the illustrated example, one or more host devices 108, 110 which may comprise, for example, client devices, personal computers (PCs), computing devices used for storage (e.g., storage servers), and other computers or peripheral devices (e.g., printers), are coupled to the respective data storage systems 102, 104 by storage network connections 112, 114. Network connection may comprise a local area network (LAN) or wide area network (WAN), for example, that utilizes Network Attached Storage (NAS) protocols, such as a Common Internet File System (CIFS) protocol or a Network File System (NFS) protocol to exchange data packets. Illustratively, the host devices 108, 110 may be general-purpose computers running applications, and may interact with the data storage systems 102, 104 using a client/server model for exchange of information. That is, the host device may request data from the data storage system (e.g., data on a storage device managed by a network storage control configured to process I/O commands issued by the host device for the storage device), and the data storage system may return results of the request to the host device via one or more network connections 112, 114.

The nodes 116, 118 on clustered data storage systems 102, 104 can comprise network or host nodes that are interconnected as a cluster to provide data storage and management services, such as to an enterprise having remote locations, for example. Such a node in a data storage and management network cluster environment 100 can be a device attached to the network as a connection point, redistribution point or communication endpoint, for example. A node may be capable of sending, receiving, and/or forwarding information over a network communications channel, and could comprise any device that meets any or all of these criteria. One example of a node may be a data storage and management server attached to a network, where the server can comprise a general purpose computer or a computing device particularly configured to operate as a server in a data storage and management system.

In an example, a first cluster of nodes such as the nodes 116, 118 (e.g., a first set of storage controllers configured to provide access to a first storage aggregate comprising a first logical grouping of one or more storage devices) may be located on a first storage site. A second cluster of nodes, not illustrated, may be located at a second storage site (e.g., a second set of storage controllers configured to provide access to a second storage aggregate comprising a second logical grouping of one or more storage devices). The first cluster of nodes and the second cluster of nodes may be configured according to a disaster recovery configuration where a surviving cluster of nodes provides switchover access to storage devices of a disaster cluster of nodes in the event a disaster occurs at a disaster storage site comprising the disaster cluster of nodes (e.g., the first cluster of nodes provides client devices with switchover data access to storage devices of the second storage aggregate in the event a disaster occurs at the second storage site).

As illustrated in the exemplary environment 100, nodes 116, 118 can comprise various functional components that coordinate to provide distributed storage architecture for the cluster. For example, the nodes can comprise a network module 120, 122 (e.g., N-Module, or N-Blade) and a data module 124, 126 (e.g., D-Module, or D-Blade). Network modules 120, 122 can be configured to allow the nodes 116, 118 (e.g., network storage controllers) to connect with host devices 108, 110 over the network connections 112, 114, for example, allowing the host devices 108, 110 to access data stored in the distributed storage system. Further, the network modules 120, 122 can provide connections with one or more other components through the cluster fabric 106. For example, in FIG. 1, a first network module 120 of first node 116 can access a second data storage device 130 by sending a request through a second data module 126 of a second node 118.

Data modules 124, 126 can be configured to connect one or more data storage devices 128, 130, such as disks or arrays of disks, flash memory, or some other form of data storage, to the nodes 116, 118. The nodes 116, 118 can be interconnected by the cluster fabric 106, for example, allowing respective nodes in the cluster to access data on data storage devices 128, 130 connected to different nodes in the cluster. Often, data modules 124, 126 communicate with the data storage devices 128, 130 according to a storage area network (SAN) protocol, such as Small Computer System Interface (SCSI) or Fiber Channel Protocol (FCP), for example. Thus, as seen from an operating system on a node 116, 118, the data storage devices 128, 130 can appear as locally attached to the operating system. In this manner, different nodes 116, 118, etc. may access data blocks through the operating system, rather than expressly requesting abstract files.

It should be appreciated that, while the example embodiment 100 illustrates an equal number of N and D modules, other embodiments may comprise a differing number of these modules. For example, there may be a plurality of N and/or D modules interconnected in a cluster that does not have a one-to-one correspondence between the N and D modules. That is, different nodes can have a different number of N and D modules, and the same node can have a different number of N modules than D modules.

Further, a host device 108, 110 can be networked with the nodes 116, 118 in the cluster, over the networking connections 112, 114. As an example, respective host devices 108, 110 that are networked to a cluster may request services (e.g., exchanging of information in the form of data packets) of a node 116, 118 in the cluster, and the node 116, 118 can return results of the requested services to the host devices 108, 110. In one embodiment, the host devices 108, 110 can exchange information with the network modules 120, 122 residing in the nodes (e.g., network hosts) 116, 118 in the data storage systems 102, 104.

In one embodiment, the data storage devices 128, 130 comprise volumes 132, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume.

Volumes are typically configured in formats that may be associated with particular storage systems, and respective volume formats typically comprise features that provide functionality to the volumes, such as providing an ability for volumes to form clusters. For example, where a first storage system may utilize a first format for their volumes, a second storage system may utilize a second format for their volumes.

In the example environment 100, the host devices 108, 110 can utilize the data storage systems 102, 104 to store and retrieve data from the volumes 132. In this embodiment, for example, the host device 108 can send data packets to the N-module 120 in the node 116 within data storage system 102. The node 116 can forward the data to the data storage device 128 using the D-module 124, where the data storage device 128 comprises volume 132A. In this way, in this example, the host device can access the storage volume 132A, to store and/or retrieve data, using the data storage system 102 connected by the network connection 112. Further, in this embodiment, the host device 110 can exchange data with the N-module 122 in the host 118 within the data storage system 104 (e.g., which may be remote from the data storage system 102). The host 118 can forward the data to the data storage device 130 using the D-module 126, thereby accessing volume 132B associated with the data storage device 130.

It may be appreciated that storage implementation functionality may be implemented within the clustered network environment 100. For example, a rule set management component and/or a rule evaluation component may be hosted by the node 116 and/or the node 118. The rule set management component may be configured to receive and verify storage functionality rules received from external client agents hosted on client devices such as the host device 108 and/or the host device 110. The rule evaluation component may be configured to implement such storage functionality rules on behalf of the external client agents hosted on the host device 108 and/or the host device 110.

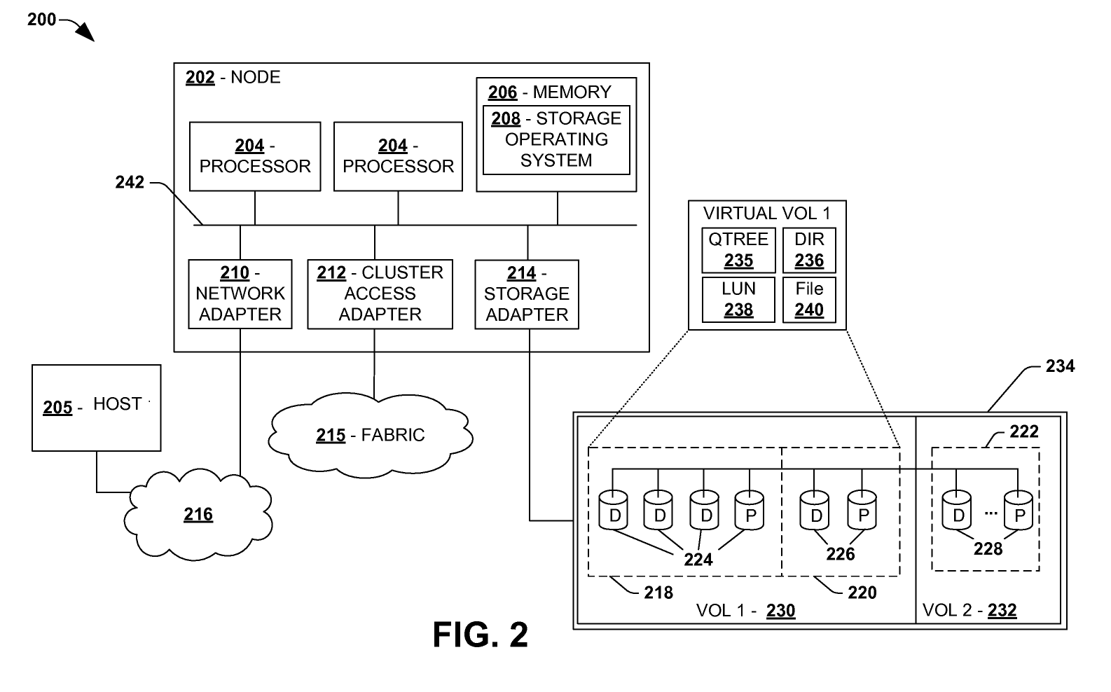

FIG. 2 is an illustrative example of a data storage system or storage site 200 (e.g., 102, 104 in FIG. 1), providing further detail of an embodiment of components that may implement one or more of the techniques and/or systems described herein. The example data storage system 200 comprises a node 202 (e.g., host nodes 116, 118 in FIG. 1), and a data storage device 234 (e.g., data storage devices 128, 130 in FIG. 1). The node 202 may be a general purpose computer, for example, or some other computing device particularly configured to operate as a storage server. A host device 205 (e.g., 108, 110 in FIG. 1) can be connected to the node 202 over a network 216, for example, to provides access to files and/or other data stored on the data storage device 234. In an example, the node 202 comprises a storage controller that provides client devices, such as the host device 205, with access to data stored within data storage device 234.

The data storage device 234 can comprise mass storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information.

The node 202 comprises one or more processors 204, a memory 206, a network adapter 210, a cluster access adapter 212, and a storage adapter 214 interconnected by a system bus 242. The storage system 200 also includes an operating system 208 installed in the memory 206 of the node 202 that can, for example, implement a Redundant Array of Independent (or Inexpensive) Disks (RAID) optimization technique to optimize a reconstruction process of data of a failed disk in an array.

The operating system 208 can also manage communications for the data storage system, and communications between other data storage systems that may be in a clustered network, such as attached to a cluster fabric 215 (e.g., 106 in FIG. 1). Thus, the node 202, such as a network storage controller, can respond to host device requests to manage data on the data storage device 234 (e.g., or additional clustered devices) in accordance with these host device requests. The operating system 208 can often establish one or more file systems on the data storage system 200, where a file system can include software code and data structures that implement a persistent hierarchical namespace of files and directories, for example. As an example, when a new data storage device (not shown) is added to a clustered network system, the operating system 208 is informed where, in an existing directory tree, new files associated with the new data storage device are to be stored. This is often referred to as “mounting” a file system.

In the example data storage system 200, memory 206 can include storage locations that are addressable by the processors 204 and adapters 210, 212, 214 for storing related software program code and data structures. The processors 204 and adapters 210, 212, 214 may, for example, include processing elements and/or logic circuitry configured to execute the software code and manipulate the data structures. The operating system 208, portions of which are typically resident in the memory 206 and executed by the processing elements, functionally organizes the storage system by, among other things, invoking storage operations in support of a file service implemented by the storage system. It will be apparent to those skilled in the art that other processing and memory mechanisms, including various computer readable media, may be used for storing and/or executing program instructions pertaining to the techniques described herein. For example, the operating system can also utilize one or more control files (not shown) to aid in the provisioning of virtual machines.

The network adapter 210 includes the mechanical, electrical and signaling circuitry needed to connect the data storage system 200 to a host device 205 over a computer network 216, which may comprise, among other things, a point-to-point connection or a shared medium, such as a local area network. The host device 205 (e.g., 108, 110 of FIG. 1) may be a general-purpose computer configured to execute applications. As described above, the host device 205 may interact with the data storage system 200 in accordance with a client/host model of information delivery.

The storage adapter 214 cooperates with the operating system 208 executing on the node 202 to access information requested by the host device 205 (e.g., access data on a storage device managed by a network storage controller). The information may be stored on any type of attached array of writeable media such as magnetic disk drives, flash memory, and/or any other similar media adapted to store information. In the example data storage system 200, the information can be stored in data blocks on the disks 224, 226, 228. The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fiber Channel Protocol (FCP)). The information is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the host device 205 over the network connection 216 (and/or returned to another node attached to the cluster over the cluster fabric 215).

In one embodiment, storage of information on arrays 218, 220, 222 can be implemented as one or more storage “volumes” 230, 232 that are comprised of a cluster of disks 224, 226, 228 defining an overall logical arrangement of disk space. The disks 224, 226, 228 that comprise one or more volumes are typically organized as one or more groups of RAIDs. As an example, volume 230 comprises an aggregate of disk arrays 218 and 220, which comprise the cluster of disks 224 and 226.

In one embodiment, to facilitate access to disks 224, 226, 228, the operating system 208 may implement a file system (e.g., write anywhere file system) that logically organizes the information as a hierarchical structure of directories and files on the disks. In this embodiment, respective files may be implemented as a set of disk blocks configured to store information, whereas directories may be implemented as specially formatted files in which information about other files and directories are stored.

Whatever the underlying physical configuration within this data storage system 200, data can be stored as files within physical and/or virtual volumes, which can be associated with respective volume identifiers, such as file system identifiers (FSIDs), which can be 32-bits in length in one example.

A physical volume corresponds to at least a portion of physical storage devices whose address, addressable space, location, etc. doesn't change, such as at least some of one or more data storage devices 234 (e.g., a Redundant Array of Independent (or Inexpensive) Disks (RAID system)). Typically the location of the physical volume doesn't change in that the (range of) address(es) used to access it generally remains constant.

A virtual volume, in contrast, is stored over an aggregate of disparate portions of different physical storage devices. The virtual volume may be a collection of different available portions of different physical storage device locations, such as some available space from each of the disks 224, 226, and/or 228. It will be appreciated that since a virtual volume is not “tied” to any one particular storage device, a virtual volume can be said to include a layer of abstraction or virtualization, which allows it to be resized and/or flexible in some regards.

Further, a virtual volume can include one or more logical unit numbers (LUNs) 238, directories 236, qtrees 235, and files 240. Among other things, these features, but more particularly LUNS, allow the disparate memory locations within which data is stored to be identified, for example, and grouped as data storage unit. As such, the LUNs 238 may be characterized as constituting a virtual disk or drive upon which data within the virtual volume is stored within the aggregate. For example, LUNs are often referred to as virtual drives, such that they emulate a hard drive from a general purpose computer, while they actually comprise data blocks stored in various parts of a volume.

In one embodiment, one or more data storage devices 234 can have one or more physical ports, wherein each physical port can be assigned a target address (e.g., SCSI target address). To represent respective volumes stored on a data storage device, a target address on the data storage device can be used to identify one or more LUNs 238. Thus, for example, when the node 202 connects to a volume 230, 232 through the storage adapter 214, a connection between the node 202 and the one or more LUNs 238 underlying the volume is created.

In one embodiment, respective target addresses can identify multiple LUNs, such that a target address can represent multiple volumes. The I/O interface, which can be implemented as circuitry and/or software in the storage adapter 214 or as executable code residing in memory 206 and executed by the processors 204, for example, can connect to volume 230 by using one or more addresses that identify the LUNs 238.

It may be appreciated that storage implementation functionality may be implemented for the data storage system 200. For example, a rule set management component and/or a rule evaluation component may be hosted by the node 202. The rule set management component may be configured to receive and verify storage functionality rules received from external client agents hosted on client devices such as the host device 205. The rule evaluation component may be configured to implement such storage functionality rules on behalf of an external client agent on the host device 205.

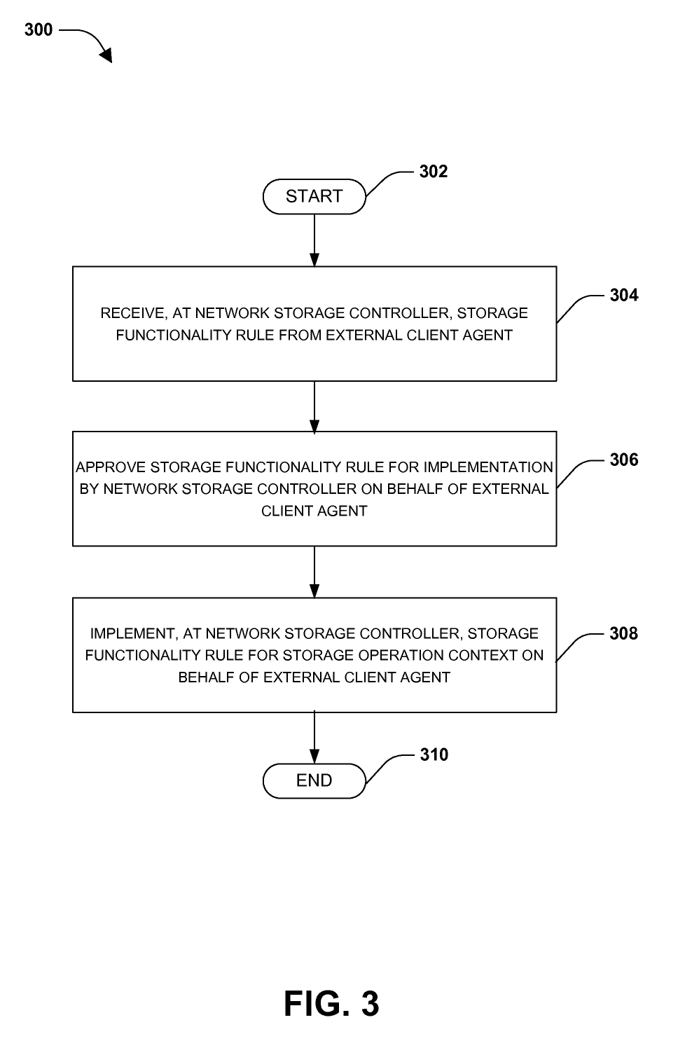

An embodiment of storage functionality rule implementation on behalf of external client agents is illustrated by an exemplary method 300 of FIG. 3. At 302, the method starts. A network storage controller may be configured to perform storage operations for clients, such as storing, retrieving, backing up, and/or organizing data on storage devices. A client device may host an external client agent configured to manage the clients (e.g., allow or deny a read operation, a write operation, and/or a create new file operation; track storage events; enforce storage quotas; etc.). A storage rule language syntax may be provided, such as from the network storage controller, to the external client agent for storage functionality rule development by the external client agent. For example, the storage rule language syntax may specify parameters and/or expressions that may be used by the external client agent to develop a script, as the storage functionality rule, written according to the storage rule language syntax.

At 304, a storage functionality rule may be received at the network storage controller from the external client agent hosted on the client device. The storage functionality rule may specify a storage quota rule (e.g., user (A) is allowed to store up to 1 GB of photos), a user type access rule (e.g., user (B) is allowed to perform storage backup operations for volume (B), but is restricted from creating new files within volume (B)), a notification rule (e.g., a storage management application, hosted on a storage server, may be notified of new file operations), a track event rule (e.g., the network storage controller may record information related to file write operations within a log), an operation allowance rule (e.g., users within a user group (A) may be allowed to read from, but not write to, files from a volume (C)), an operation blocking rule (e.g., users within a user group (B) may be blocked from writing files to a volume (D) more than twice a day), a count tracking rule (e.g., a count of new file creation operations may be maintained), a tracing rule (e.g., tracing may be turned on for users within a user group (C)), etc. In an example, the storage functionality rule may comprise a script written according to the storage rule language syntax. For example, the storage functionality rule may comprise parameters and/or expressions formatted according to the storage rule language syntax.

At 306, the storage functionality rule may be verified as adhering to the storage rule language syntax. Responsive to verifying the storage functionality rule, the storage functionality rule may be approved for implementation by the network storage controller on behalf of the external client agent. If the storage functionality rule does not adhere to the storage rule language syntax, then the external client agent may be instructed to modify the storage functionality rule accordingly.

At 308, responsive to identifying a storage operation context that corresponds to the storage functionality rule approved for implementation, the storage functionality rule may be implemented for the storage operation context on behalf of the external client agent. The storage operation context may corresponds to a storage operation (e.g., a write operation, a read operation, a backup operation, a migration operation, etc.), a file creation operation, a file access operation, a client access operation (e.g., a user identifier, a user group, or other identifying information associated with a client accessing the network storage controller), an event (e.g., a new volume creation event, a storage device power on event, a storage device failure event, a migration completion event, etc.), and/or a variety of other storage operations. In an example where the storage functionality rule specifies that user (A) is limited to 2 GB of mp3 storage, the storage functionality rule may be implemented for a user (A) mp3 file creation storage operation context where the 2 GB storage limit may be enforce for the mp3 file creation (e.g., a storage operation context repository, local to the network storage controller, may be queried to identify a current mp3 file storage size for the user (A), which may be compared with a size of the mp3 file that is to be created). In this way, storage functionality rules may be implemented on behalf of the external client agent by the network storage controller.

In an example, the storage functionality rule may be implemented without accessing the external client agent (e.g., without sending the user (A) mp3 file creation storage operation context to the external client agent, and without waiting for an instruction from the external client agent as to whether the mp3 file creation should be allowed or denied). In an example, a rule evaluation component, hosted on the network storage controller, may be configured to implement the storage functionality rule. The rule evaluation component may be hosted within a virtual machine. The rule evaluation component may be configured to persist a result of the storage functionality rule implementation to persistent storage, which may mitigate loss of the result otherwise occurring from a failure or other issue associated with the virtual machine. In another example, the result of the storage functionality rule implementation may be stored within a storage result repository that is local to the network storage controller. In an example, the external client agent may be provided with query access to the storage result repository. In another example, the storage result repository may be periodically synchronized with the external client agent.

New storage functionality rules may be received and/or implemented by the network storage controller. For example, a new storage operation context may be identified (e.g., a user (B) may attempt to delete a volume (C)). Responsive to the new storage operation context not corresponding to at least one storage functionality rule approved for implementation, a notification of the new storage operation context may be sent to the external client agent (e.g., or other external client agent that may be identified as having registered an interest in such a storage operation context). Responsive to receiving an instruction for processing the new storage operation context from the external client agent, the new storage operation context may be processed according to the instruction (e.g., user (B) may be allowed to delete one volume per week, and thus user (B) may be blocked from deleting volume (C) because user (B) may have already deleted a volume for the week). In an example, the instruction may comprise a new storage functionality rule. Responsive to verifying that the new storage functionality rule adheres to the storage rule language syntax, the new storage functionality rule may be approved for implementation by the network storage controller on behalf of the external client agent. Responsive to identifying a second storage operation context that corresponds to the new storage functionality rule approved for implementation, the new storage functionality rule may be implemented for the second storage operation context on behalf of the external client agent (e.g., the network storage controller may allow user (B) to delete a volume (F) because the network storage controller determined that user (B) has not deleted a volume within the past week, which may be determined by the network storage controller by querying a storage operation context repository, locally maintained by the network storage controller, comprising user (B) volume deletion contextual information). In this way, new storage functionality rules, specified by various external client agents, may be implemented by the network storage controller. At 310, the method ends.

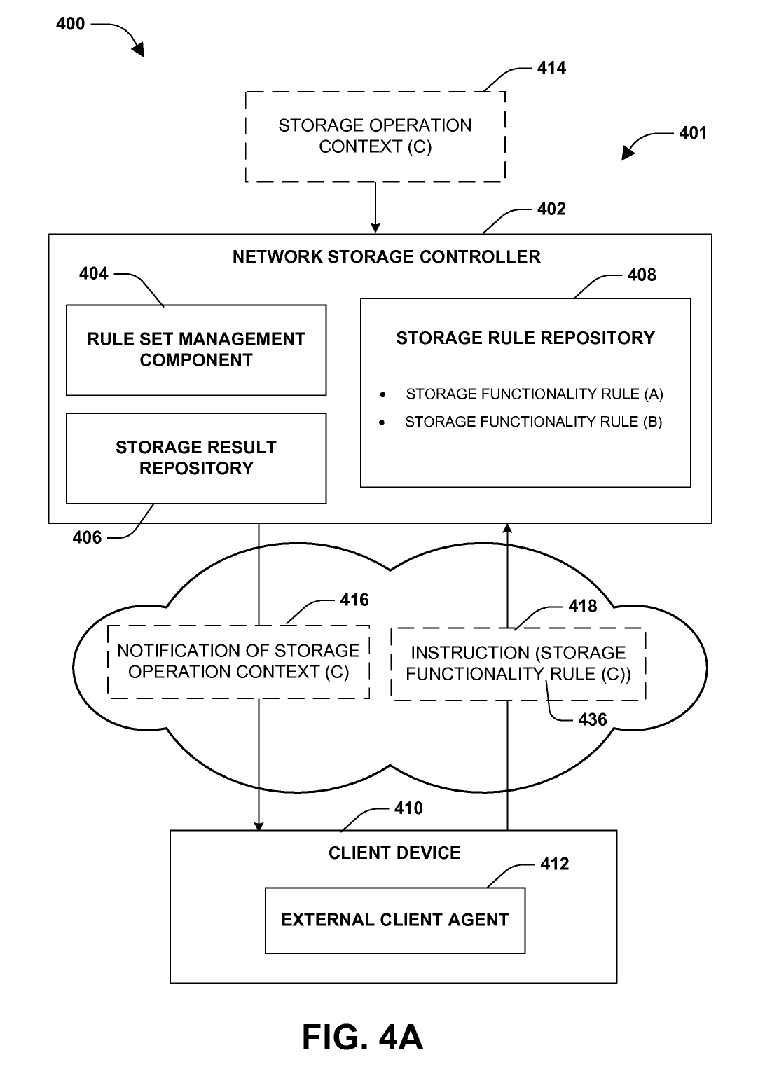

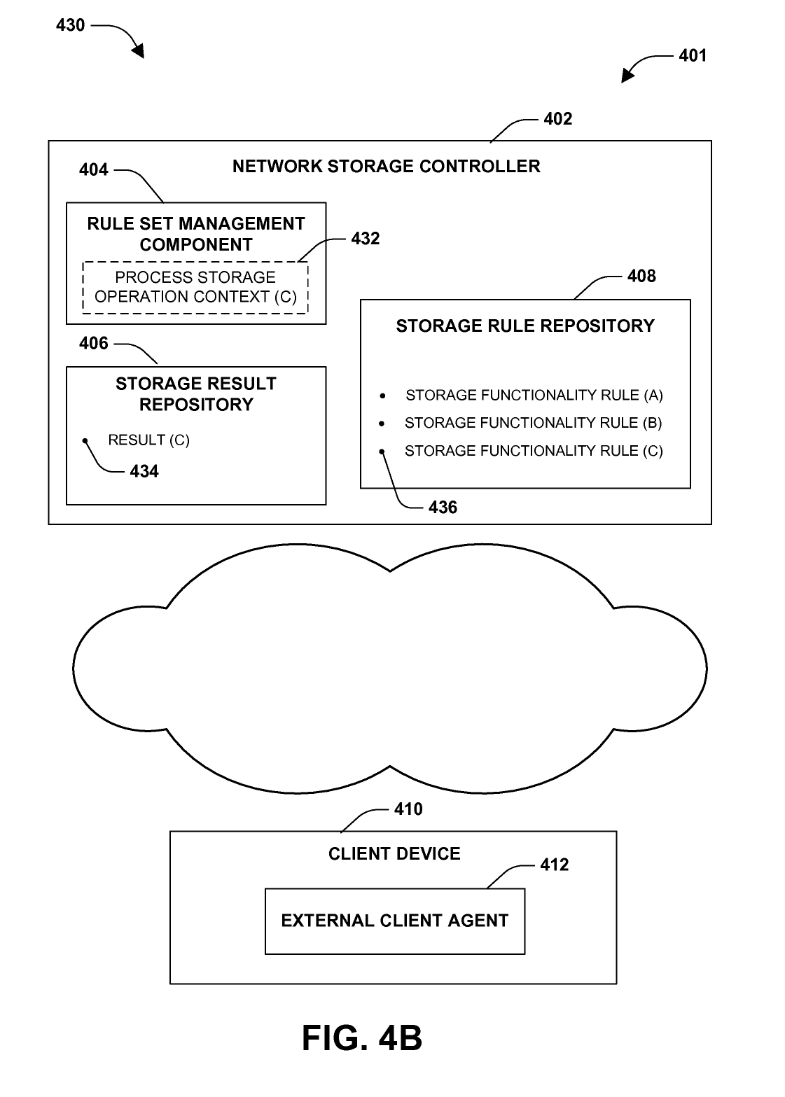

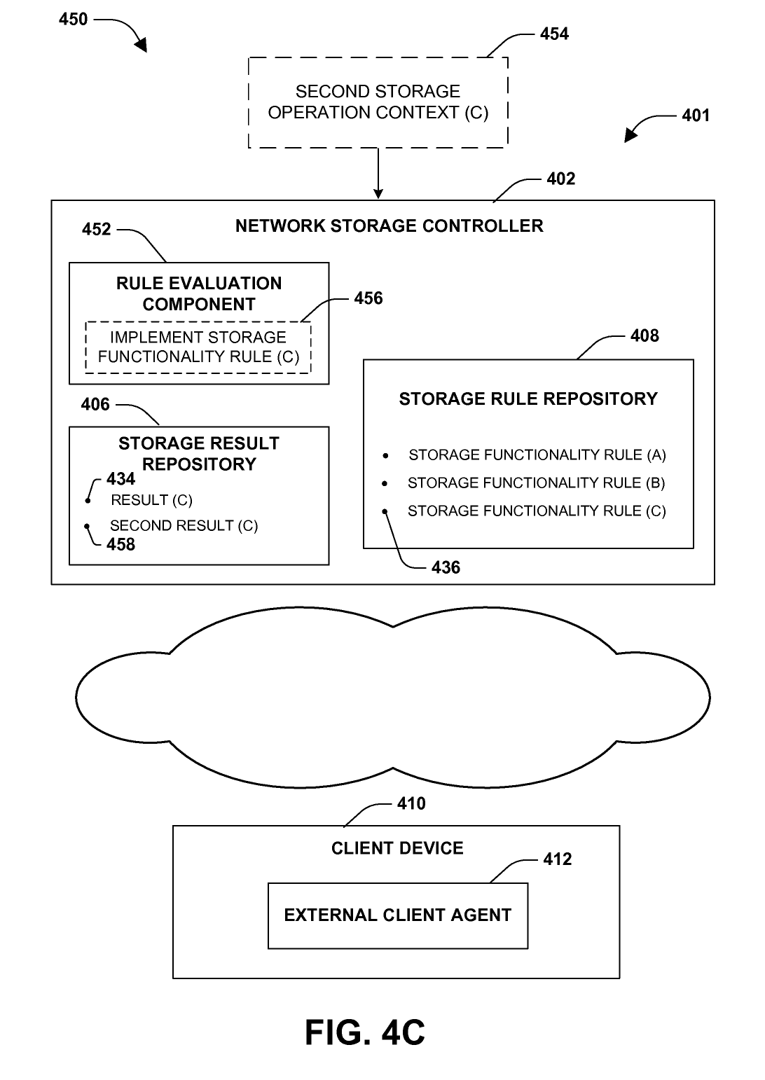

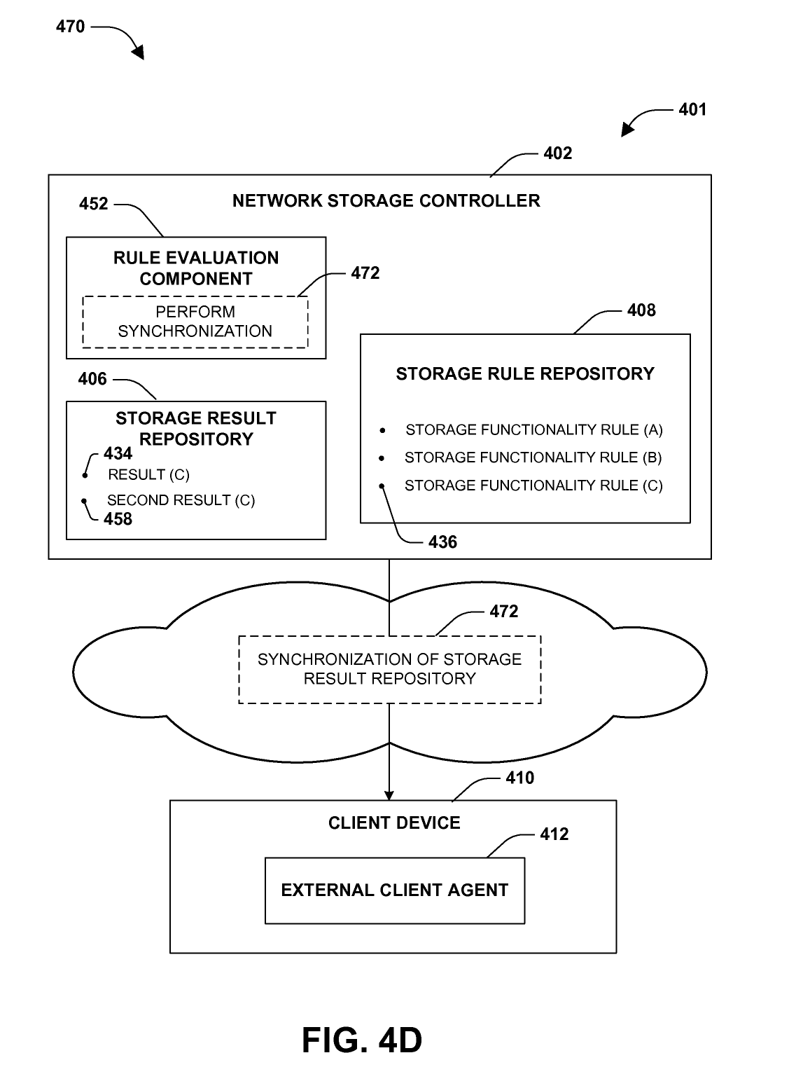

FIGS. 4A-4D illustrate examples of a system 401, comprising a rule set management component 404 and/or a rule evaluation component 452 hosted by a network storage controller 402, for storage functionality rule implementation. FIG. 4A illustrates an example 400 of the network storage controller 402 receiving a storage operation context (C) 414. For example, the storage operation context (C) 414 may indicate that a user (A) of user group (B) is attempting to create a new file within a volume (C). The rule set management component 404 may determine that the storage operation context (C) 414 does not correspond to at least one storage functionality rule within a storage rule repository 408 maintained by the network storage controller 402. Accordingly, a notification 416 of the storage operation context (C) 414 may be sent to an external client agent 412 hosted on a client device 410. The external client agent 412 may send an instruction 418 to the rule set management component 404.

FIG. 4B illustrates an example 430 of the rule set management component 404 processing 432 the storage operation context (C) 414 based upon the instruction 418. For example, the instruction 418 may indicate that users within user group (B) are allowed to create new files within volume (C) that are less than 5 mb, and thus a current attempt by user (A) to create the new file may be blocked based upon the new file being 7 mb in size. A result (C) 434 of the processing 432 may be stored within a storage result repository 406. In an example, the instruction 418 may comprise a storage functionality rule (C) 436. For example the storage functionality rule (C) 436 may specify a new file creation size limit of 5 mb for users within user group (B) that create new files within volume (C). The rule set management component 404 may store the storage functionality rule (C) 436 within the storage rule repository 408 for subsequent implementation of the storage functionality rule (C) 436 at the network storage controller 402 on behalf of the external client agent 412.

FIG. 4C illustrates an example 450 of the rule evaluation component 452 implementing 456 the storage functionality rule (C) 436 on behalf of the external client agent 412. For example, a second storage operation context (C) 454 (e.g., a user (F) within the user group (B) may be attempting to create a new file within volume (C)) may be received by the network storage controller 402. The rule evaluation component 452 may determine that the second storage operation context (C) 454 corresponds to the storage functionality rule (C) 436. Accordingly, the rule evaluation component 452 may implement 456 the storage functionality rule (C) 436 for the second storage operation context (C) 454 on behalf of the external client agent 412. For example, the rule evaluation component 452 may allow the user (F) to create a new file that is 3 mb. A second result (C) 458 of the implementation 456 (e.g., indicating that the user (F) was allowed to create the new 3 mb file) may be stored within the storage result repository 406.

FIG. 4D illustrates an example 470 of synchronizing 472 the storage result repository 406 with the external client agent 412. The rule evaluation component 452 may determine that the synchronization 472 may be performed based upon various criteria, such as expiration of a synchronization timer, a synchronization request received from the external client agent 412, occurrence of an event (e.g., a threshold number of results may be stored within the storage result repository 406), etc. Accordingly, the synchronization 472 of the storage result repository 406, such as the result (C) 434 and/or the second result (C) 458, may be synchronized with the external client agent 412.

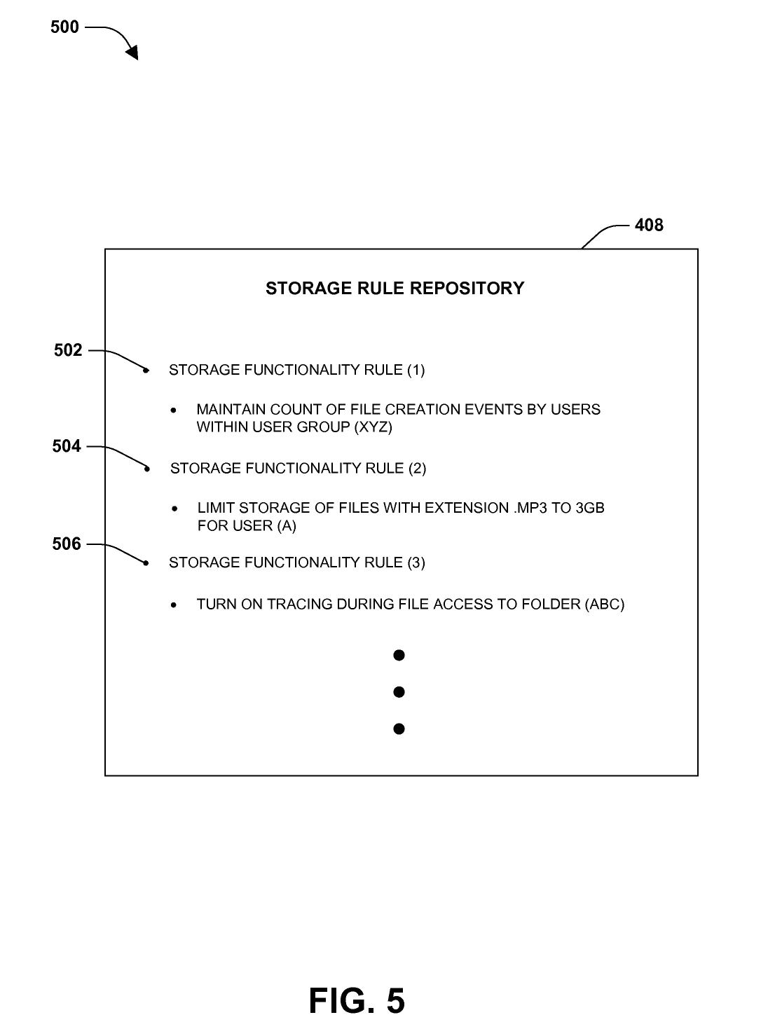

FIG. 5 illustrates an example 500 of one or more storage functionality rules maintained within the storage rule repository 408 hosted by the network storage controller 402. A first storage functionality rule 502, provided by a first external client agent hosted on a first client device, may specify that the network storage controller 402 is to maintain a count of file creation events by users within user group (XYZ). A second storage functionality rule 504, provided by a second external client agent hosted on a second client device, may specify that the network storage controller 402 is to limit storage of files within extension .mp3 to 3 GB for user (A). A third storage functionality rule 506, provided by the second external client agent, may specify that the network storage controller 402 is to turn on tracing during file access to folder (ABC). In this way, the rule evaluation component 452 may implement storage functionality rules, maintained within the storage rule repository 408, on behalf of external client agents.

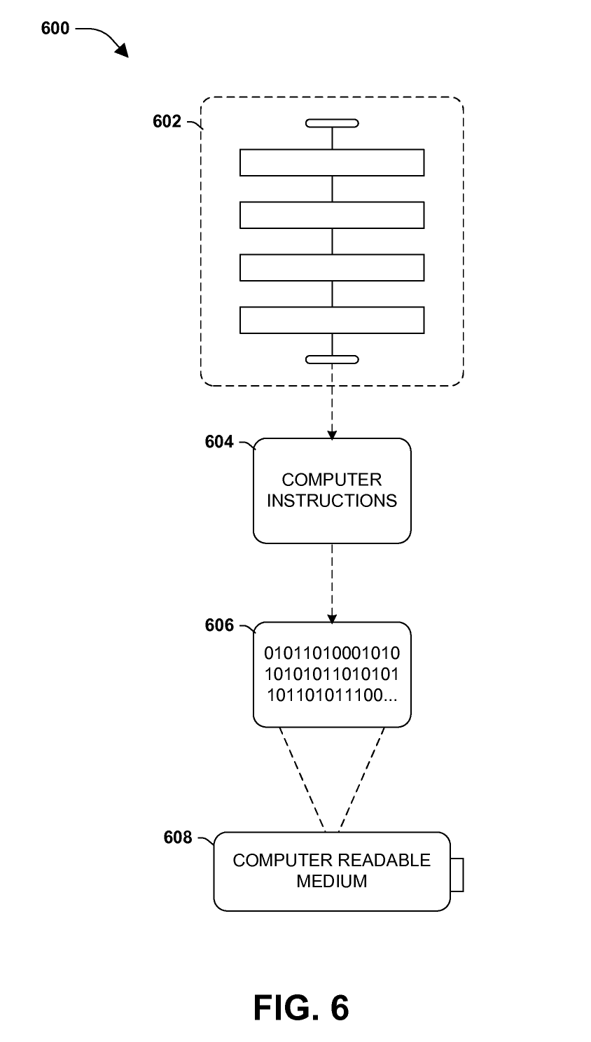

Still another embodiment involves a computer-readable medium comprising processor-executable instructions configured to implement one or more of the techniques presented herein. An example embodiment of a computer-readable medium or a computer-readable device that is devised in these ways is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 300 of FIG. 3, for example. In some embodiments, the processor-executable instructions 604 are configured to implement a system, such as at least some of the exemplary system 401 of FIGS. 4A-4D, for example. Many such computer-readable media are contemplated to operate in accordance with the techniques presented herein.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), EEPROM and/or flash memory, CD-ROMs, CD-Rs, CD-RWs, DVDs, cassettes, magnetic tape, magnetic disk storage, optical or non-optical data storage devices and/or any other medium which can be used to store data.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for storage functionality rule implementation on behalf of external client agents, comprising:
a rule set management component, hosted on a network storage controller, configured to:
receive a storage functionality rule from an external client agent hosted on a client device; and
responsive to verifying that the storage functionality rule adheres to a storage rule language syntax, approve the storage functionality rule for implementation by the network storage controller on behalf of the external client agent; and
a rule evaluation component, hosted on the network storage controller, configured to:
responsive to identifying a storage operation context that corresponds to the storage functionality rule approved for implementation, implement the storage functionality rule for the storage operation context on behalf of the external client agent.

2. The system of claim 1, the storage operation context comprising at least one of a storage operation, a file creation operation, a file access operation, a client access operation to the network storage controller, or an event.

3. The system of claim 1, the rule evaluation component configured to:
implement the storage functionality rule without accessing the external client agent.

4. The system of claim 1, the rule evaluation component configured to:
store a result of the storage functionality rule implementation within a storage result repository that is local to the network storage controller.

5. The system of claim 4, the rule evaluation component configured to:
periodically synchronize the storage result repository with the external client agent.

6. The system of claim 1, the rule set management component configured to:
provide the storage rule language syntax to the external client agent for storage functionality rule development by the external client agent.

7. The system of claim 1, the storage functionality rule comprising a script written according to the storage rule language syntax.

8. The system of claim 1, the storage functionality rule comprising one or more parameters and one or more expressions formatted according to the storage rule language syntax.

9. The system of claim 1, the rule evaluation component hosted within a virtual machine, and the rule evaluation component configured to persist a result of the storage functionality rule implementation to persistent storage.

10. The system of claim 1, the rule set management component configured to:
identify a new storage operation context;
responsive to the new storage operation context not corresponding to at least one storage functionality rule approved for implementation, send a notification of the new storage operation context to the external client agent; and
responsive to receiving an instruction for processing the new storage operation context from the external client agent, process the new storage operation context according to the instruction.

11. The system of claim 10, the instruction comprising a new storage functionality rule, and the rule set management component configured to:
responsive to verifying that the new storage functionality rule adheres to the storage rule language syntax, approve the new storage functionality rule for implementation by the network storage controller on behalf of the external client agent.

12. The system of claim 11, the rule evaluation component configured to:
responsive to identifying a second storage operation context that corresponds to the new storage functionality rule approved for implementation, implement the new storage functionality rule for the second storage operation context on behalf of the external client agent.

13. The system of claim 4, the rule evaluation component configured to:
provide the external client agent with query access to the storage result repository.

14. The system of claim 1, the storage functionality rule specifying at least one of:
a storage quota rule;
a user type access rule;
a notification rule;
a track event rule;
an operation allowance rule;
an operation blocking rule;
a count tracking rule; or
a tracing rule.

15. A method for storage functionality rule implementation on behalf of external client agents, comprising:
receiving, at a network storage controller, a storage functionality rule from an external client agent hosted on a client device;
responsive to verifying that the storage functionality rule adheres to a storage rule language syntax, approving the storage functionality rule for implementation by the network storage controller on behalf of the external client agent; and
responsive to identifying a storage operation context that corresponds to the storage functionality rule approved for implementation, implementing, at the network storage controller, the storage functionality rule for the storage operation context on behalf of the external client agent.

16. The method of claim 15, comprising:
identifying a new storage operation context;
responsive to the new storage operation context not corresponding to at least one storage functionality rule approved for implementation, sending a notification of the new storage operation context to the external client agent; and
responsive to receiving an instruction for processing the new storage operation context from the external client agent, processing the new storage operation context according to the instruction.

17. The method of claim 16, the instruction comprising a new storage functionality rule, and the method comprising:
responsive to verifying that the new storage functionality rule adheres to the storage rule language syntax, approving the new storage functionality rule for implementation by the network storage controller on behalf of the external client agent; and
responsive to identifying a second storage operation context that corresponds to the new storage functionality rule approved for implementation, implementing, at the network storage controller, the new storage functionality rule for the second storage operation context on behalf of the external client agent.

18. A system for remote storage functionality rule implementation, comprising:
an external client agent, hosted on a client device, configured to:
receive a storage rule language syntax from a rule set management component hosted on a network storage controller;
define a storage functionality rule, to be implemented by a rule evaluation component hosted on the network storage controller upon occurrence of a corresponding storage operation context associated with the network storage controller, using the storage rule language syntax; and
send the storage functionality rule to the rule evaluation component for implementation.

19. The system of claim 18, the storage functionality rule comprising a script written according to the storage rule language syntax.

20. The system of claim 18, the external client agent configured to:
query a storage result repository, local to the network storage controller, for one or more results of storage functionality rule implementation.
